(19) United States
(12) Patent Application Publication
(10) Pub. No.: US 2020/0203986 A1
(43) Pub. Date: Jun. 25, 2020

(54) PORTABLE TOOL EQUIPPED WITH A PNEUMATIC MOTOR AND A SUPERCAPACITOR FOR CHARGING A BATTERY-SUPPLYING POWER TO DEVICES

(71) Applicant: ETABLISSEMENTS GEORGES RENAULT, Saint Herblain (FR)

(72) Inventors: Simon Barreau, Nantes (FR); Clement Beautes, La Chevroliere (FR); Julien Latouche, Nantes (FR)

(21) Appl. No.: 16/723,379

(22) Filed: Dec. 20, 2019

(30) Foreign Application Priority Data
Dec. 21, 2018 (FR) 1873997

(51) Int. Cl. H02J 7/34; B25B 21/02; B25B 23/145

(52) U.S. Cl. CPC H02J 7/345; B60L 2210/10; B25B 23/1456; B25B 21/02

(57) ABSTRACT

A portable tool with discontinuous operation equipped with a pneumatic motor and an element driven in motion intermittently by the motor by a kinematic chain. The portable tool includes a generator for generating electric energy out of the kinetic energy of the element in motion, and at least one supercapacitor capable of storing the electric energy produced by the generator, and at least one battery. The battery is charged by the supercapacitor when the generator no longer produces electric energy. In this way, the combined use of a supercapacitor and a battery enables power to be supplied for longer periods to accessories embedded in the tool or electrically connected to the tool. The tool recovers the maximum energy produced by the motions and stores it in an embedded battery so as to be able to use it at any time thereafter.

### 1. Field of the Invention

The field of the invention is that of a portable industrial tool equipped with a pneumatic motor driving an element in a discontinuous motion, and a means of conversion of kinetic energy into electrical energy. More specifically, the invention relates to the fact that the electrical energy powers a capacitor that charges a battery to supply power to devices mounted on the tool.

### 2. Prior Art

The context of the invention is that of the use of pneumatic tooling and tools in the context of industrial production and especially in that of the automobile industry. Such tools are for example screwdrivers, sanders or grinders, impact wrenches and so on.

An impact wrench is a tool more commonly used for the tightening and loosening of nuts and screws. This type of tool has the advantage of minimizing or even eliminating torque feedback or backlash in the operator's hands. This tool can be electric or pneumatic. The type of mechanism habitually used in pneumatic impact wrenches is called a “rebounding” mechanism such as the “twin hammer” mechanism. This mechanism is driven by a rotating motor and behaves like an intermittent clutch. The motor drives the cage and the hammers of the mechanism against the square drive known by those skilled in the art as an “anvil”.

It is often necessary to provide better lighting for the surface situated in the front part of the tool. Indeed, these tools are most often used in garages to repair trucks and automobiles and also in poorly lit areas. In the case of screws situated in narrow volumes, the handling operation can suffer from a lack of visibility and it is necessary to light up the area during production and maintenance operations. The lack of visibility can lead to a loss of productivity and quality of work.

In the case of pneumatic tools, there is no need for electrical wires powering any unspecified electrical element for the work of the tool. It is therefore generally not possible to use energy provided by wires to power a lamp. At present, various methods of lighting exist. Of them, there is the following non-exhaustive list specifying certain advantages and drawbacks:

The hand lamp. This device is lightweight but cannot be taken into every location and creates a shadow when the tool is in front.

The light pen. This device is light and can be taken anywhere but creates a shadow when the tool is in front.

Torch before tool. This device clearly lights up the area before the tool but extends the nose of the tool and reduces accessibility to working areas. It uses the electrical energy of the device, thus diminishing its autonomy.

Battery-operated portable torch. This apparatus lights up the working area well and can be fixedly attached to the tool, but its autonomy depends on the capacity of its battery. During recharging, the battery has to be removed, and placed on a charger and then the reverse operation has to be carried out, and this takes a lot of time.

For powering a light source to light up the area before the tool, there is therefore a real need for a device to provide electrical energy to a torch. There are known ways of embedding a dynamo in a tool to produce a voltage used to power a light source. Since this dynamo produces energy only with the rotation of the motor, there are also known ways of using a battery that is charged by the dynamo and powers a device even after the rotation of the motor is stopped. In the case of a tool with discontinuous or intermittent motions, the dynamo generates high intensity in intermittent or erratic spurts, and this is not practical for charging a battery. This energy is clipped and a major part of it is lost.

There is therefore a real need for a more efficient technique for producing electric energy out of the discontinuous motions produced by an industrial tool.

More generally, the electric energy produced can be used for other devices which can also improve the use of pneumatic tools. It can indeed be useful to equip these tools with short-range communications means (by Wi-Fi or Bluetooth) to transmit the results of a screwing or an unscrewing operation, to feed a sound signal or a light signal reporting on the state of the tool or to localize the tool within a production line. The electric energy can also power sensors to measure the torque, totalize the time of use of the tool, detect shocks or impacts and/or record the measurements made by these sensors in a memory.

As in the case of a light source, these devices need electricity to work, and this energy must come from a reliable and high-performance means.

### 3. PRESENTATION OF THE INVENTION

An exemplary embodiment of the present application proposes a portable tool with discontinuous operation equipped with a pneumatic motor and an element driven in motion intermittently by the motor by means of a kinematic chain, comprising a means for generating electric energy out of the kinetic energy of the element in motion. The tool furthermore comprises at least one supercapacitor capable of storing the electric energy produced by the means of generation, and at least one battery, said battery being at least charged by the supercapacitor when the means of generation no longer produce electric energy.

In this way, the combined use of a supercapacitor and of a battery makes it possible to power accessories embedded in the tool or electrically connected to the tool for longer periods. The tool recovers the maximum amount of electric energy produced by the motions and stores it in an embedded battery so that it can be used at any time thereafter.

According to a first embodiment, the tool comprises a voltage converter capable of being powered by the supercapacitor and/or by the means of generation to provide a constant and regulated voltage applied to the terminals of the battery. In this way, the charging of the battery is more efficiently regulated, and its service life is optimal.

According to another embodiment, the means for generating electric energy is a generator that provides an alternating voltage and connected to a bridge of rectifier diodes. In this way, the electric energy source is easy to make and embed in a tool.

According to another embodiment, the tool comprises at least one accessory working on electric energy, said accessory being capable to being powered by electric energy stored in said battery. In this way, the accessory can continue to be powered even if the supercapacitor has given out all its energy.

According to another embodiment, the voltage converter is capable of being powered by the battery to provide said accessory with constant and regulated voltage. In this way, this mode of providing energy is suited to detectors that necessitate well regulated voltage.

According to another embodiment, the accessory forms part of the set of the following accessories: torque-measurement device, vibration-measurement device, temperature-measurement device, pressure-measurement device, flow-rate measurement device, position-measurement and/or orientation-measurement and/or motion-measurement device, sound-emitting device, display device, lighting device, geolocation system, communications system and data-recording system. In this way, this system can power a very large number of different accessories.

According to another embodiment, the tool comprises a lighting system powered by said supercapacitor. In this way, the tool can light up a working area, without requiring complex electronic circuits.

According to another embodiment, the tool comprises a trigger which, when pressed, triggers the movement of the motor, and a means to command the lighting system, the command means turning said lighting system on when said trigger of the tool is pressed. In this way, the user of the tool has his work area lit up as soon as he uses it.

According to another embodiment, the command means triggers the extinguishing of said lighting system at the end of a determined duration after the pressure on the trigger of the tool has been released. In this way, the lighting control system saves on stored energy.

According to another embodiment, the tool is an impact wrench.

### 4. DESCRIPTION OF THE FIGURES

Other features and advantages of the invention shall appear from the following description of particular embodiments, given by way of a simple illustratory and non-exhaustive example and from the appended drawings of which:

FIG. 1 illustrates a view in perspective or three-quarter view of a portable tool with discontinuous operation according to an example of an embodiment;

FIG. 2 is an electrical diagram presenting the main elements used to generate electric energy from kinetic energy;

FIG. 3 illustrates an example of a view of an energy production line for providing a simple power supply to a non-voltage-regulated lighting means;

FIG. 4 illustrates an example of a view of an energy production line for supplying power to devices embedded in a tool requiring improved regulated voltage.

### 5. DESCRIPTION OF PARTICULAR EMBODIMENTS

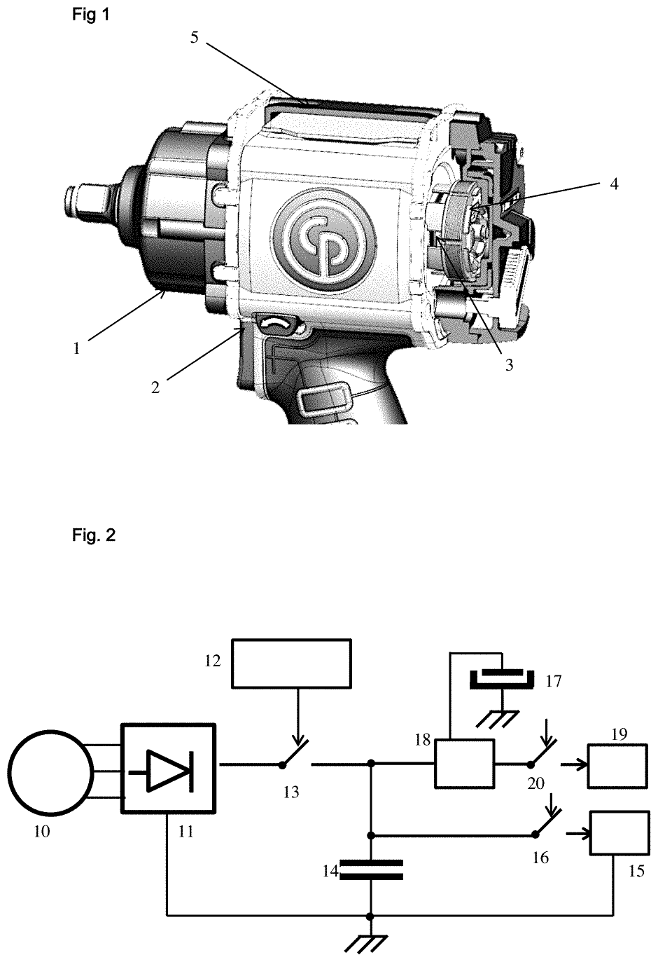

Referring to FIG. 1, we present a portable tool with discontinuous operation equipped with a pneumatic motor and an element driven in motion intermittently. The tool 1 represented is typically a pneumatic impact wrench. Such a tool is connected to a pressurized-gas supply feeder tube and is equipped with a trigger 2. Pressure on said trigger opens a clack valve releasing gas that turns on a turbine 3 and a motor 4 triggering the rotation of the chuck and the generation of impacts.

On such an impact tool, the time taken to put the motor into rotation is very short (5 to 50 impacts of 5 to 200 ms in 1 second). The electric generator fixedly attached to the motor therefore produces energy in large quantities but does so during short instants. An exemplary embodiment of the disclosure enables the recovery of the maximum amount of energy produced and its storage in a storage system 5 comprising especially a supercapacitor and an associated battery. Thus, this energy can be used for a long time after it has been produced, for example one month later. The solution described presents an efficient compromise amongst the factors of compactness, weight, charging speed, low discharge rate and price.

An exemplary embodiment of the disclosure thus makes it possible to recover energy in continuous or “free-speed” mode as well as in impact mode.

The ratio of vibrations finally between the impact mode and the free-speed mode is high and implies the ability to harvest energy from a wide range of generator output voltages. Starting with one volt, in order to recover impulse energy, the voltage at maximum speed in impact mode could be ten times greater than the voltage in free-speed mode.

FIG. 2 illustrates an electric diagram showing the main elements used to generate electrical energy from kinetic energy. The tool 1 is provided with a generator 10, mounted on the rotor of the tool, that produces an alternating current when the rotor is in rotation, whatever its sense. The coil is advantageously mounted to produce three-phase voltage. The voltage is transmitted to a diode rectifier bridge 11 to produce rectified voltage. A control circuit hereinafter called a “central processing unit” 12 manages at least the charging of the capacitors and of the battery of the storage system 5. This central processing unit commands the state of a switch 13 which controls the passage of the current coming from the rectifier bridge 11 towards a supercapacitor 14.

The term “supercapacitor” designates a capacitor with a capacity of over 100 millifarads. It is generally polarized. The central processing unit 12 measures the voltage at the terminals of the supercapacitor and, as soon as this voltage goes beyond its rated value, for example 5 volts, the switch 13 is open, thus limiting the rise in voltage of the capacitor and protecting it from surge voltage. The central processing unit can be a simple comparator working at very low voltage of <1 Volt powered by a very low consumption (voltage reference) circuit. In another embodiment, the central processing unit can be a microcontroller and be able to drive the switches to control the power supply to the accessories, as is described here below.

When the voltage returns to below the rated voltage of the supercapacitor, the switch 13 is closed. The electricity produced by the rectifier bridge 11 charges the supercapacitor 14 when the switch 13 is closed, and can also power a first accessory 15 when a second switch 16 is closed. This first accessory is for example a light-emitting means, comprising for example one or more LED diodes. This type of accessory does not require, for its operation, a well-regulated power supply and a power supply voltage included within a narrow interval. In certain cases, it can be noted that the light amplitude of the light-emitting means provides information on the charge of the supercapacitor.

A supercapacitor gets discharged in causing the voltage across its terminals to drop, thus preventing certain components from working. In addition, once the capacitor is completely charged, the energy supplied to it thereafter is lost. An exemplary embodiment of the disclosure provides for the addition of a battery 17 that is charged by means of the voltage across the terminals of the supercapacitor 14. The rated charging voltage of the battery 17 is produced by a DC/DC (DC for “direct current”) converter 18, which provides a constant output voltage from a fluctuating input voltage, as is the case when the capacitor gets discharged. In this way, the battery 17 gets charged by using the energy stored by the supercapacitor when the generator 10 no longer produces any electricity.

The energy stored in the battery is available at any time in using the DC/DC converter 18 which extracts the electricity stored in electrochemical form and provides it to accessories 19 that need a better regulated power supply voltage. According to this scheme, it is not obligatory for the voltage of the battery to be equal to the voltage transmitted to these second accessories. The power supply to these the second accessories is done under the control of a third switch 20.

The second accessories 19 are for example:
a torque-measurement device, typically one or more fixed strain gauges, fixed to an element of the transmission system, that gets deformed during work,
a vibration-measurement device, typically an accelerometer, associated with a fall detector to detect falls of the tool and a means of counting the number of falls,
a temperature-measurement device,
a pressure-measurement device,
a flow-rate measurement device,
a device for measuring the position and/or orientation and/or motion, of an accelerometer, gyroscope, gyrometer type,
a sound-emitting device, typically a buzzer,
a display device, typically colored indicator lights (LED technology),
a lighting device, typically working by flash means to save on battery, for example for a visual localizing function,
a geolocation system, typically a transponder,
a communications system using Bluetooth or Wi-Fi technology or any other short-range communications means,
a data-recording system, for example a tool identifier, typically an electronic memory.

These accessories which generally have electronic functions possess very different energy consumption power values and require specific management. The accessories are not solely elements fixedly attached to the tool but can also be elements electrically connected to it, by wires for example.

It is clear that an exemplary embodiment of the disclosure covers the case where the tool powers several accessories. For example, the tool 1 has an impact detector transmitting signals to the central processing unit 12 which counts them and updates, in a memory, a fall counter counting the falls of this tool. When this total reaches a critical threshold, the central processing unit sends a message via a radio link to trigger a maintenance operation.

After having described the different hardware elements constituting an exemplary embodiment of the disclosure, we shall describe the way in which they work together.

At rest the switch 13 is open, and it closes as soon as the voltage output from the rectifier bridge 11 reaches one volt to charge the supercapacitor 14. When the trigger 2 of the tool is pressed in, the supercapacitor gets charged and provides energy to the DC/DC converter 18, and this converter starts charging the battery 17. A first accessory 15 can then be powered by the voltage across the terminals of the supercapacitor in closing the switch 16. The converter can also provide a properly regulated voltage to the second accessories 19 in using energy coming from the generator 10 and the rectifier bridge 11. The second accessories 19 are powered by closing the switch 20.

When the tool stops working as a result of the release of the trigger, the supercapacitor 14 is no longer charged by the generator 10 and the rectifier bridge 11. Its voltage drops as it supplies power to the converter 18 which continues to charge the battery 17. At a certain point in time, the voltage is too low to make the converter work and the charging of the battery is interrupted. This voltage threshold below which the converter stops charging the battery can for example be one volt. If the voltage provided by the converter is above a certain threshold, for example four volts, the charging of the battery is interrupted.

The converter can however continue to provide well-regulated voltage in using the energy stored in the battery, to give it to the second accessories 19. It can therefore be seen that this system enables a battery to supply power to accessories for a longer duration than in the case of the use of a supercapacitor alone. When the voltage of the battery too descends below a certain threshold, three volts for example, the converter no longer has enough energy to work and it is no longer possible to supply power to any accessory.

The voltage thresholds specified here above are given by way of an example and depend especially on the battery technology used.

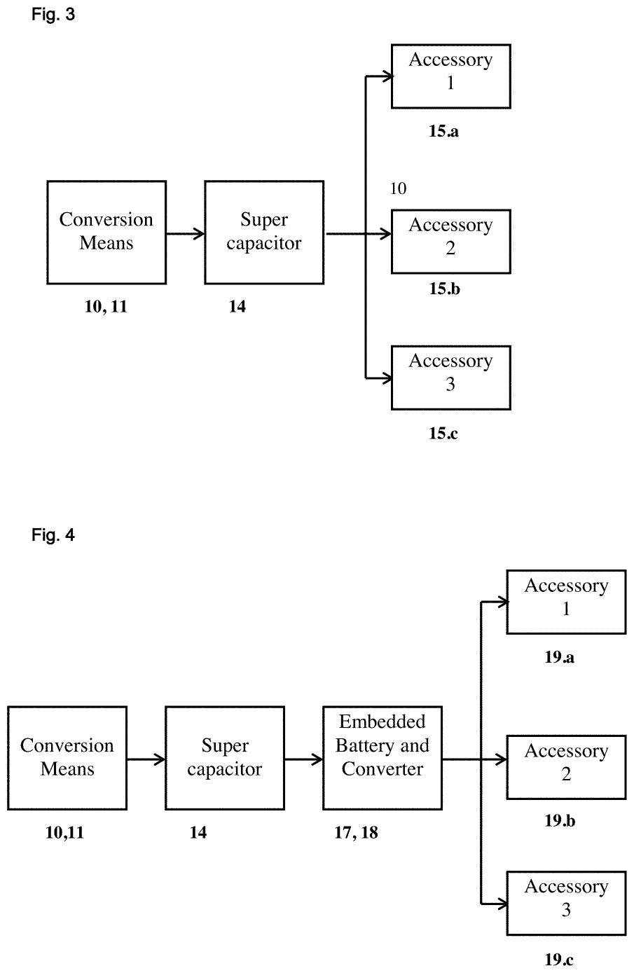

FIG. 3 illustrates an example of a view of an energy production line for a simple powering of a non-voltage-regulated lighting means. According to this first embodiment, the conversion means (generator 10 and rectifier bridge 11) provide a rectified voltage to charge the supercapacitor 14. The voltage across the terminals of the capacitor is used to power one or more first accessories 15.a, 15.b, 15.c of the LED type lighting means.

FIG. 4 illustrates an example of a view of an energy production line for supplying power to devices embedded on a tool and necessitating a more regulated voltage. According to this particular embodiment, the conversion means charge the supercapacitor which charges the battery through the DC/DC converter. The output voltage given by the converter is used to power one or more accessories 19.a, 19.b, 19.c such as a measuring device using an electronic sensor and a communications circuit.

It can be clearly understood that the two configurations described with reference to FIG. 3 and FIG. 4 are perfectly capable of being combined and that it is possible for a tool to supply power, at the same time, to an accessory 15 by means of a supercapacitor 14 and to another accessory 19 using the battery 17.

According to a simple embodiment, the accessories 15 and/or 19 can be powered by switches 16 and 20 manually operated by the user of the tool. According to one alternative embodiment, the lighting and extinguishing of the accessories are commanded by push buttons accessible on the casing of the tool, and electrically connected to the central processing unit 12. Let us take the case where the central processing unit receives a signal and determines whether the command can be executed, and the case where the battery charge is just sufficient to power the central processing unit and not sufficient to turn on an accessory consuming far too much energy. In this case the command will remain ineffective. According to another alternative embodiment, pressure on the trigger is detected by a sensor that sends a signal to the central processing unit 12. Upon reception of the signal, the central processing unit 12 commands the closing of a switch 16 enabling the lighting system to be powered. According to an improvement, the central processing unit triggers the extinguishing of the lighting system at the end of a determined period of time after the relaxation of pressure on the trigger of the tool. In this way, the working area before the tool can remain lit up for a certain period of time after the use of the tool.

An exemplary embodiment of the disclosure is aimed especially at providing an efficient solution to at least some of the different problems of the prior art.

In particular, At least one embodiment produces electric energy out of kinetic energy and to do so independently of the times when the elements are in motion.

At least one embodiment recovers the maximum amount of electric energy produced by the motions and stores it in an embedded battery so as to be able to use it at any time thereafter.

At least one embodiment produces electrical energy intended for elements for powering lighting, communications, measurements and computation.

Although described through a certain number of detailed exemplary embodiments, the proposed device comprises different variants, modifications and improvements that will appear in an obvious manner to those skilled in the art, it being understood that these different variants, modifications and improvements are within the scope of the invention as defined by the following claims. In addition, different aspects and characteristics described here above can be implemented together or separately or else substituted for one another and all the different combinations and sub-combinations of the aspects and characteristics form part of the scope of the invention. In addition, it can happen that certain devices described here above do not incorporate all the modules and functions planned for the embodiments described.

1. A portable tool with discontinuous operation and comprising:
a pneumatic motor;
an element driven in motion intermittently by the motor by a kinematic chain; and
a generator which is configured to generate electric energy out of the kinetic energy of the element in motion;
at least one supercapacitor capable of storing the electric energy produced by the generator; and
at least one battery, said battery being at least charged by the supercapacitor in response to the generator no longer producing electric energy.

2. The portable tool according to claim 1, which further comprises a voltage converter capable of being powered by the supercapacitor and/or by the generator to provide a constant and regulated voltage applied across terminals of the battery.

3. The portable tool according to claim 1, wherein the generator provides an alternating voltage and is connected to a bridge of rectifier diodes.

4. The portable tool according to claim 1, which comprises at least one accessory working on electric energy, said accessory being capable of being powered by electric energy stored in said battery.

5. The portable tool according to claim 4, which further comprises a voltage converter capable of being powered by the supercapacitor and/or by the generator to provide a constant and regulated voltage applied across terminals of the battery, and wherein the voltage converter is capable of being powered by the battery to provide said accessory with constant and regulated voltage.

6. The portable tool according to claim 4, wherein said at least one accessory forms part of the set of the following accessories: torque-measurement device, vibration-measurement device, temperature-measurement device, pressure-measurement device, flow-rate measurement device, position-measurement and/or orientation-measurement and/or motion-measurement device, sound-emitting device, display device, lighting device, geolocation system, communications system and data-recording system.

7. The portable tool according to claim 1, which further comprises a lighting system powered by said supercapacitor.

8. The portable tool according to claim 7, which further comprises: a trigger which, when pressed, triggers movement of the motor; and command means to command the lighting system, the command means turning said lighting system on when said trigger of the tool is pressed.

9. The portable tool according to claim 8, wherein the command means triggers extinguishing of said lighting system at an end of a determined duration after pressure on the trigger of the tool has been relaxed.

10. The portable tool according to claim 1, wherein said tool is an impact wrench.
